(19) United States
(12) Patent Application Publication
(10) Pub. No.: US 2015/0379088 A1
(43) Pub. Date: Dec. 31, 2015

(54) ACTIVITY PROPOSING DEVICE

(71) Applicant: DENSO CORPORATION, KARIYA-CITY, AICHI-PREF. (JP)

(72) Inventor: Yasuhiro SHIMIZU, Tokoname-city (JP)

(21) Appl. No.: 14/442,261

(22) PCT Filed: Sep. 26, 2013
(86) PCT No.: PCT/JP2013/005729

§ 371 Date: May 12, 2015

(30) Foreign Application Priority Data
Nov. 14, 2012 (JP) 2012-250451

(51) Int. Cl. G06F 17/30

(52) U.S. Cl. CPC G06F 17/30528; G06F 17/30554

(57) ABSTRACT

An activity proposing device includes: a mood estimation device that estimates a mood of a user at a present time based on an activity record of the user; a proposal determination device that determines an activity to be proposed to the user using the mood estimated by the mood estimation device as a selection condition of the activity to be proposed; and a display unit that displays the activity determined by the proposal determination device. Thus, the device performs destination proposal according to a mental strain of the user. A moving record is updated automatically, so that time and effort of an operation of the user are reduced.

### CROSS REFERENCE TO RELATED APPLICATION

This application is based on Japanese Patent Application No. 2012-250451 filed on Nov. 14, 2012, the disclosure of which is incorporated herein by reference.

### TECHNICAL FIELD

The present disclosure relates to an activity proposing device for estimating a mood of an user and proposing an activity corresponding to the mood of the user.

### BACKGROUND ART

A device for estimating a mood of an user based on a song selected by the user and proposing a drive plan (i.e., an activity for driving to a destination) corresponding to the mood is well known as a device for proposing an activity according to the mood of the user (Patent Literature No. 1)

In the Patent Literature No. 1, the device generates the driving plan based on the song selected by the user after the device prompts the user to select the song, which is used for generation of the driving plan. The device estimates a song, which has been frequently selected among a history of song that had been listened by the user in the past, as a favorite song, and generates the driving plan based on the song.

The Patent Literature No. 1 discloses a construction for selecting the song, which meets the mood of the user, when the driver wants to generate the driving plan. In this construction, it is necessary to add a step for selecting the song. In addition, it is not always easy to consider selecting the song as a music meeting with the mood at that time.

Further, the Patent Literature No. 1 discloses a construction for estimating the song, which is frequently selected by the user among the history of the songs that had been listened by the user in the past, as a favorite song. It is not necessary for this construction to add the step for selecting the song.

However, the mood of the user is usually changed from moment to moment. Thus, the music selected frequently in the record of the music listened in the past may not always reflect on the mood of the user at that time. Accordingly, in the above constitution, it may be more likely not to propose a driving plan corresponding to the mood of the user at that time.

Further, when a proposal of activity other than a drive such as a proposal for purchasing a product according to the mood of the user is performed, it is not possible to propose the activity according to the mood of the user even if a technique described in the patent literature 1 is applied.

### PRIOR ART LITERATURES

### Patent Literature

Patent Literature 1: JP-2002-365075 A

### SUMMARY OF INVENTION

It is an object of the present disclosure to provide an activity proposing device that proposes an activity according to a mood of a user with reducing a task of an operation of the user.

According to an aspect of the present disclosure, an activity proposing device includes: a mood estimation device that estimates a mood of a user at a present time based on an activity record of the user; a proposal determination device that determines an activity to be proposed to the user using the mood estimated by the mood estimation device as a selection condition of the activity to be proposed; and a display unit that displays the activity determined by the proposal determination device.

Previous activities of the user greatly influence the mental strain of the user. For example, when the overtime work longer than usual continues, the user feels tired. When the user continuously leaves at the regular time recently although the overtime work has been a lot a short time ago, the user may feel to train by himself or herself using spare time, which is generated since the working time becomes short. Accordingly, in the present embodiment, the activity record of the user is successively updated, and the mental strain of the user at that time is estimated based on the activity record, so that the mental strain of the user at that time is estimated with high accuracy. Further, the estimated mental strain is used as the selection condition of the activity to be proposed, and thus, the activity to be proposed is determined. Accordingly, the proposal according to the mood of the user is executed.

Further, the activity record stored in the memory unit, which is used for the estimation of the mood of the user, is successively updated by obtaining the activity information of the user with the record updating device. Thus, time and effort of an operation of the user are reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram showing a construction of a vehicular navigation device having a function as an activity proposing device according to the present disclosure;

FIG. 2 is a flowchart showing a moving proposal process for a destination executed by a navigation ECU and a related process;

FIG. 3 is a diagram showing an example of determination standards used in step S2 of FIG. 2;

FIG. 4 is a flowchart showing a detail of a process in step S4 of FIG. 2;

FIG. 5 is a diagram showing a concrete example in a case where a destination proposal is performed by executing the process in FIG. 2;

FIG. 6 is a flowchart showing a strain learning process executed by the navigation ECU; and

FIG. 7 is a flowchart showing a facility destination learning process executed by the navigation ECU.

### EMBODIMENTS FOR CARRYING OUT INVENTION

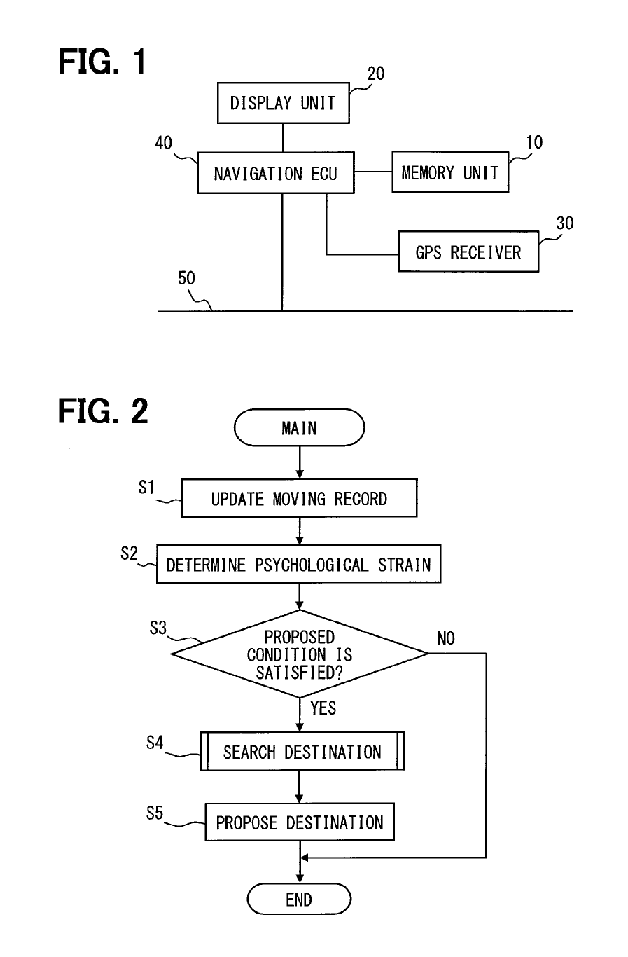

An embodiment of the present disclosure will be explained with reference to the drawings. As shown in FIG. 1, a navigation device 1 having a function as an activity proposing device according to the present disclosure includes a memory unit 10, a display unit 20, a GPS receiver 30 and a navigation ECU 40.

The memory unit 10 includes a memory medium, which is writable. The memory medium stores road map data. The road map data includes various information (i.e., facility information) relating to facilities in addition to a node and a link indicative of a shape of a road. Further, the memory unit 10 stores an activity record of the user. The display unit 20 displays a road map and a content of an activity, which is proposed for the user. The GPS receiver 30 receives a signal transmitted from a GPS artificial satellite, and successively determines coordinates of a current position based on the received signal.

The navigation ECU 40 is a computer having a CPU, a ROM, a RAM and the like, which are not shown in the drawings, therein. The CPU utilizes a temporal memorizing function of the RAM, and executes a program stored in the ROM, so that the CPU performs a read-write control in the memory unit 10 and a display control in the display unit 20. Further, the navigation ECU 40 successively obtains the current position, which is determined by the GPS receiver 30. Further, the ECU 40 successively obtains various information such as a speed of a vehicle and the like via a CAN 50.

The navigation ECU 40 executes a route guidance based on the obtained various information with displaying the map and a symbol indicative of the current position of the vehicle on the display unit 10. Further, the navigation ECU 40 according to the present embodiment executes a moving proposal (i.e., a proposal of the destination) for the destination to the user and various processes necessary for the moving proposal (such as a generating and updating process of an activity record, an estimation process of a mental strain of the user, and a determination process of the destination to be proposed).

The activity record stored in the memory unit 10 will be explained before explaining the proposal of the destination and the like executed by the navigation ECU 40.

The activity record is a record indicative of information (i.e., activity information) showing the activity of the user in connection with date. The activity information is not limited to a specific matter as long as the navigation ECU 40 can obtain the activity information. For example, the activity information includes moving information and purchasing information. Alternatively, the activity information may include both of the moving information and the purchasing information. Thus, the activity information may include multiple types of activity information.

Further, the activity information such as the moving information and the purchasing information may be preferably obtained as much as possible. Alternatively, it may not be necessary to obtain a whole of the activity information. For example, in case of the moving information, the activity information may include only the moving information when the user gets on the vehicle. In this case, moving information of the vehicle is used as the moving information of the user. Further, when the moving record of the user by foot is successively stored by a mobile terminal carried by the user, and the vehicular navigation device 1 has a vehicular communication device for communicating with the mobile terminal, the moving information of the user may be obtained from the mobile terminal via the communication.

The moving information according to the present embodiment needs not include a moving route. The moving information may include only a starting place, a stop place, a starting time of the starting place, and an arrival time of the stop place. When the user leaves a hole as the starting place, arrives at the stop place, and goes home from the stop place, the stop place becomes the starting place in a trip home. In this case, the moving record includes the starting time from the stop place and the arrival time to the home.

The purchasing record may be also obtained from a record stored in the mobile terminal via the communication between the mobile terminal and the vehicular communication device. Alternatively, the present disclosure may be applied to the mobile terminal having the navigation function instead of the vehicular navigation device 1, and the mobile terminal has a position detection function and an Internet connection function for purchasing a product. In this case, the above-described walking record and the purchasing record may be obtained from a memory of the mobile terminal itself.

The activity record may be preferably identified by each user so that the activity record is classified by each user. Alternatively, in case of the vehicular device according to the present embodiment, a determined person may be a driver of the vehicle. Alternatively, in case of the mobile terminal, it is higher possibility than the vehicular device that only the same person uses the mobile terminal. Thus, it is not necessary to identify the user.

FIG. 2 shows the moving proposal process to the destination and its related processes executed by the navigation ECU 40. The starting time of the process in FIG. 2 is time when the activity information is obtained for updating the activity record.

The activity record includes various issues as described above. Here, it is assumed that the moving record of the vehicle as the activity record is stored in the memory unit 10. As described above, the moving record includes the starting place, the stop place, the starting time at the starting place, and the arrival time at the stop place. Accordingly, the process in FIG. 2 is executed at the starting time and the arrival time. Here, the determination of the start and the arrival may be performed by various well-known methods such as a on and off determination of an ignition switch (or a power source switch) and a detection of getting in and getting off a driver seat.

At step S1 of the moving record updating process, the moving information of the user is obtained, and the moving record of the user stored in the memory unit 20 is updated. Here, the moving record includes the starting place, the stop place, the starting time at the starting place, and the arrival time at the stop place. The moving information (i.e., the activity information) includes the position of the starting place and the starting time or the position of the stop place and the arrival time. Thus, at step S1, specifically, the above moving information is obtained, and the moving information is added to the moving record stored in the memory unit 20.

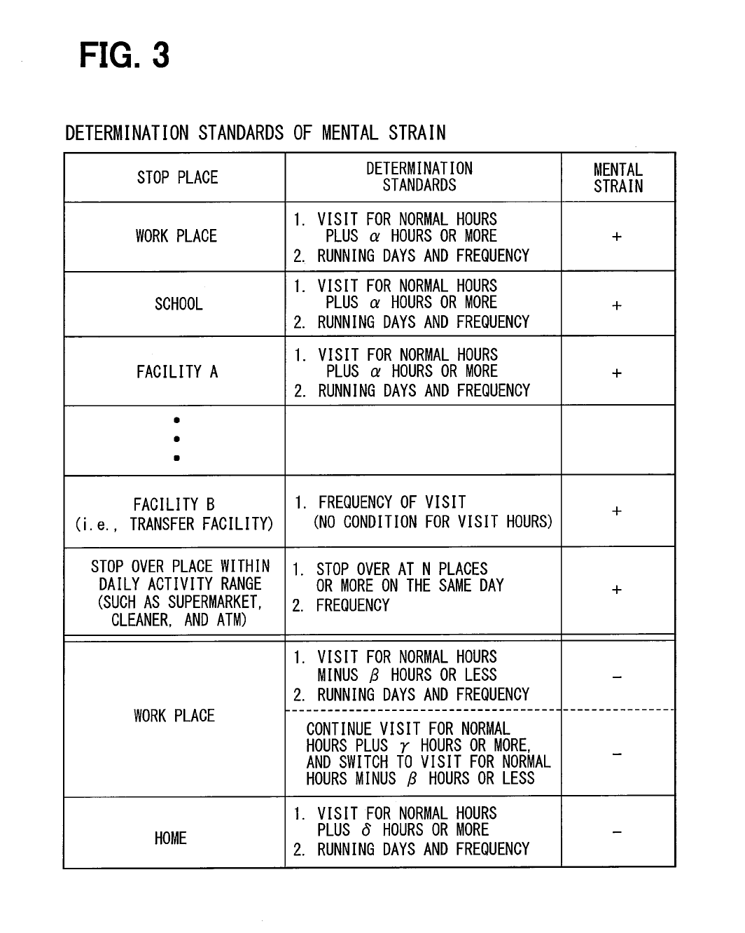

Successively, at step S2, based on the moving record updated at step S1, the mental strain of the user is determined. The determination standards set for each stop place are used in the determination of the metal strain. FIG. 3 shows an example of the determination standards. In FIG. 3, the mark “+” in a column of the mental strain means that the mental strain is high. On the other hand, the mark “−” means that the mental strain is low.

FIG. 3 shows a work place, a school, a facility A, a facility B, and a stop over place within a daily activity range as a stop place, which provides the mark “+” of the mental strain. Two determination standards No. 1 and No. 2 are prepared for each of the work place and the school. The determination standard No. 1 is a criteria of the visit hours per one time. The determination standard No. 2 is a criteria relating to the number of days, on which the determination standard No. 1 is satisfied, and the standard No. 2 includes the running days and the frequency.

The visit hours per one time is determined to exceed the standard when the visit time is equal to or more than the normal visit hours plus α hours. The normal visit hours are an average visit time during a predetermined past period. This is calculated based on the activity record stored in the memory unit 20. Here, when the activity record is not sufficiently stored for calculating the normal visit time, the normal visit time is set to be predetermined constant time. Further, when the average visit time of others is obtained, the normal visit time may be set to the average visit time of others. Even when the average visit time is capable of being calculated based on the activity record, the normal visit time may be set to the average visit time of others. Here, the “normal visit time” corresponds to the standard visit time. The “normal” visit hours in other columns of FIG. 3 also corresponds to the standard visit time. The α hours are a predetermined constant value. For example, α hours are two hours or three hours. α hours correspond to certain time described in a mood estimation device. Further, β hours, γ hours, and δ hours in other columns of FIG. 3 correspond to certain time described in the mood estimation device.

One of the running days and the frequency in the determination standard No. 2 may be used. The determination value of the running days is, for example, from one day to five days. The frequency is, for example, three days per one week assuming that one week is a standard.

When the visit time at the work place or the school is longer than usual, many persons feel that the mental strain is high. Further, in general, as this situation continues longer, the strain felt by a person becomes higher. Thus, the above described determination standard is set.

Two determination standards of the visit time per one time and the days (i.e., the running days and the frequency) are prepared for the facility A, similar to the work place and the school. The facility A is, for example, a hospital. Alternatively, the facility A may be other types of facilities. Further, a facility, which is determined as the facility having high mental strain, is also the facility A. The determination standards of the visit time, the running days and the frequency with regard to the facility A are preliminary set to initial values. The determination standards may be changed from the initial values based on a learning. A method of the learning will be described later.

The facility B is a facility, at which the user drops and picks up. For example, the facility B is a nursery school, a cram school, or the like. The visit time of the user at the facility, at which the user drops and picks up, is short for estimating the mental strain. However, if the transportation to and from these facilities continues, some persons may feel that the mental strain is high. Thus, the visiting frequency is used for the determination standard for determining the mental strain, independently from the visit time. The determination value of the visiting frequency of the transportation facility is preliminary set. The determination value of the visiting frequency is a frequency during a period longer than the period of the frequency in a case where the visit time is considered. For example, the frequency is one month. The visit time itself is short, and therefore, when the period is almost the same as the case where the visit time is considered, it is considered that the mental strain is not high. The determination value of the visiting frequency is also set preliminary. Here, the determination value may be also changed based on the learning.

Here, the work place or the school is the transportation facility for some persons. On the other hand, the work place or the school is the facility having a possibility for long visit time for a person who is picked up and dropped. Thus, two determination standards may be set with regard to one facility such that one determination standard is prepared for determining the mental strain based on the visit time and the running days, and the frequency, and the other determination standard is prepared for determining the mental strain based on only the visiting frequency.

The stop over place within the daily activity range is, for example, a supermarket, a cleaner, and an automatic teller machine (i.e., ATM), as exemplified and shown in FIG. 3. If a person stops over multiple times at these stop over places on the same day, the person may feel the mental strain. Thus, the stop over place within the daily activity range is set according to the determination standard that a person stops over at N places or more on the same day. N represents the number of determination facilities. N is the natural number equal to or larger than two. For example, N is 3, 4 or 5. The daily activity range is determined by the activity record of the memory unit 10.

Two determination standards are set with regard to the stop over place within the daily activity range. One determination standard is that a person stops over at N places or more on the same day, and the other determination standard is the frequency, at which the person stops over at N places or more on the same day. The frequency is calculated during a period of a few weeks or one month. For example, if the frequency is equal to or more than one time per a week during the period, it is determined that the mental strain is high. The determination value with respect to the frequency is preliminary set. Further, the determination value may be changed by the learning.

Next, a facility having the low mental strain will be explained. FIG. 3 shows the work place and the home as a facility having a low mental strain (i.e., the mark “−”). The work place is explained as the facility having the mental strain of “+.” The work place is a place, at which a person feels certain mental strain even if the person stays the place for a normal visit time. When the visit time at the work place is shorter than the normal visit time, some persons may feel that the mental strain is very low. Thus, the determination standard No. 1 is set such that the visit time for one time is equal to or smaller than the normal visit time minus β hours. β hours are preliminary set. For example, β hours are two or three hours. An idea for the normal visit time is the same as a case where it is determined that the mental strain is high.

Further, the running days and the frequency are set as the determination standard No. 2. The standard No. 2 may be one of the running days and the frequency, similar to a case where it is determined that the mental strain is high. The concrete values of the running days and the frequency may be the same as a case where it is determined that the mental strain is high. It is not necessary to set the same.

Further, a standard with respect to the work place is set as another determination standard such that a state that the visit for the normal visit hours plus γ hours or more continues for predetermined running days is switched to the visit for the normal hours minus β or less. Here, γ is the positive number equal to or smaller than α. The running days may be the same as the running days under a condition arranged just above the condition in FIG. 3. Alternatively, the running days may be different from the running days. The condition is a condition for determining whether the mental strain rapidly falls down lower after continuing the state that the mental strain is comparatively high. When the visit time rapidly falls down shorter after the state that the visit time is comparatively long continues, some persons may feel according to a gap thereof that the mental strain becomes low. Further, when a person has time suddenly, the person may get time on his or her hands. Thus, the above determination standard is set.

Here, the determination standard with respect to high mental strain facility other than the work place (such as the school) for determining that the mental strain is low may be set similar to the work place.

FIG. 3 shows the home as a facility, at which it is determined that the mental strain is low. Since the home is a rest place, the facility, at which it is determined that the mental strain is low, includes the home. Here, the mental strain of “−” means that the mental strain becomes much low. It is not determined that the mental strain becomes much low when the visit time is normal. In the present embodiment, when a person stays at the home for time longer than usual, it is determined that the mental strain becomes low. The determination standard includes the determination standard No. 1 and No. 2. The determination standard No. 1 is a visit for the normal hours plus δ hours or more. The determination standard No. 2 is the running days and the frequency. the meaning of the normal is the same as above. The standard No. 2 may be one of the running days and the frequency. The running days and the frequency are preliminary set. Further, the running days and the frequency may be changeable.

Thus, explanation of FIG. 3 is performed. A relationship shown in FIG. 3 is stored in the memory unit 10, the memory unit of the navigation ECU 40 or the like. At step S2 of FIG. 2, the mental strain is determined based on the determination standard shown in FIG. 3.

At step S3, it is determined whether the condition (i.e., a proposed condition) for proposing the destination to the user is satisfied. The proposed condition includes a condition whether the determination standard is satisfied and a condition of the proposing timing.

The former condition is determined by comparing the determination standard set at each stop place with the activity record, as described above. The condition for the proposing timing relates to time when it is detected that the user gets in a vehicle, or time when it is detected that the user instructs a proposal. The detection of the user getting in the vehicle is provided by various well-known methods such as detection of open/close of a door, and detection of a passenger sitting down a driver seat. The instruction of the proposal from the user is performed by operating an operation unit not shown in the drawings and arranged in the vehicular navigation device 1.

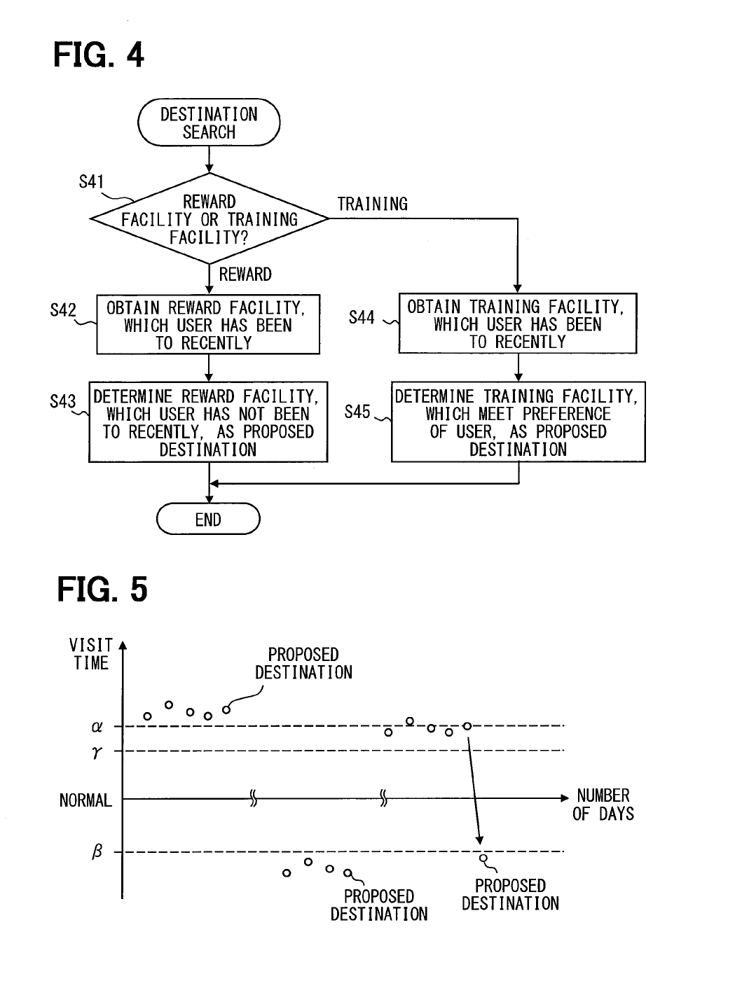

When the determination at step S3 is NO, the process in FIG. 2 ends. On the other hand, when the determination is YES, it goes to step S4. At step S4, the destination search is executed. The detail of the process at step S4 will be shown in FIG. 4.

First, at step S41, it is determined whether the proposed facility is a reward facility or a training facility. When it is determined that the mental strain is high, it is determined that the reward facility is to be searched, in order to propose to reward to a person momentarily since the person is trying hard. Thus, the reward facility is a strain reduction facility for reducing the mental strain. On the other hand, it is determined that the mental strain gets too low, it is determined that the training facility is to be searched, in order to propose to increase the mental strain, which has gotten too low, by performing self-training. Thus, the training facility is a strain increasing facility for increasing the mental strain.

The reward facility is, for example, a confectionery store or a coffee shop. The training facility is, for example, a language school or a sport gym. The facility information of the road map data preliminary provides which facility is the reward facility or the training facility. Alternatively, the user can register a concrete facility as the reward facility or the training facility. The confectionery store and the coffee shop described above as examples of the reward facility relate to a drinking and eating facility. Alternatively, other categories of the facility may be set as the reward facility.

Then, at step S42, the reward facility, which the user has been to recently, is obtained from the activity record of the memory unit 10. The period of “recently” is appropriately set. For example, the period may be set for the past three months by now.

At step S43, the proposed destination is determined by removing the facility obtained at step S42 from the facility set as the reward facility. Thus, the proposed destination is the facility, to which the user has not gone recently. The facility, to which the user has not gone recently, includes the facility, to which the user has never been.

Many facilities remain as a candidate even when the facility obtained at step S42 is removed. The facility outside business hours and the facility disposed outside of a predetermined distance from the current position or the home are removed from the remained candidate. The candidate is narrowed to the facility having a category different from the reward facility obtained at step S42. The proposed destination is determined randomly among narrowed facilities.

When the destination having a category different from the facility, which the user has been to recently, is proposed, the user has an impression, which is different from usual. Thus, the user has an impression that the reward is proposed. Here, when it is determined according to the activity record that a possibility for the user to go to a facility in the same category is high after the high mental strain continues, the destination in the same category as the facility, which has gone recently, may be proposed.

At step S44, the training facility, which the user has been to recently, is obtained from the activity record in the memory unit 10. The “recent” period may be appropriately settable. For example, the recent period may be the same in step S42.

At step S45, the training facility, which meets the preference of the user, is determined as the proposed destination. The recent preference of the user with respect to the training facility is determined according to the facility obtained at step S44. The preference of the user may be determined by a category. Alternatively, the preference may be determined by a specific facility.

When the preference is determined by the category, the category of the training facility, which meets the preference of the user, is determined to the largest number of category among the facilities obtained at step S44. In this case, the facility outside business hours and the facility disposed outside of a predetermined distance from the current position or the home are removed from the facility in the determined category. Then, the proposed destination is determined randomly among remained facilities. When the preference of the user is determined by the concrete facility, the proposed destination is determined to the concrete facility, which the user visits the most frequently among the facilities obtained at step S44.

After step S43 or step S45 is executed, it returns to steps in FIG. 2. Then, step S5 is executed. At step S5, the destination searched at step S4 is displayed on the display unit 20 together with a predetermined message indicative of the reward or the training as the reason why the destination is proposed.

Here, in addition, the reference day (i.e., the starting day of the running days and the frequency) for determining the mental strain is changed to the present day. Even if the destination is proposed, the mental strain of the user is not reset. However, when the reference day for determining the mental strain is not changed, the destination proposal continues, and therefore, it provides botheration to the user. On the other hand, even when the reference day for determining the mental strain is changed to the present day, the destination proposal is executed again under a condition that the activity record of the user satisfies with the determination standard. Thus, even when the destination is proposed, and the reference day for determining the mental strain is changed to the present day, the destination proposal is performed at a predetermined interval.

After step S5 is executed, the process in FIG. 2 ends. When the guiding instruction to the destination proposed at step S5 is input into an operation unit of the vehicular navigation device 1 not shown in the drawings, the route guidance to the destination starts.

FIG. 5 shows a concrete example in a case where the destination proposal is executed by performing the process in FIG. 2. The example in FIG. 5 uses the work place as the visit place. As shown in FIG. 5, when the days, on which the visit time exceeds the normal hours plus α hours, continues, the destination is proposed. The destination to be proposed in this case is the reward facility. On the other hand, when the days, on which the visit time falls below the normal hours minus β hours, continues, the destination is also proposed. The destination to be proposed in this case is the training facility. Further, when the visit time becomes the normal hours minus β hours or less after the days, on which the visit time exceeds the normal hours plus γ hours, continues, the destination is also proposed. The destination to be proposed in this case is the training facility.

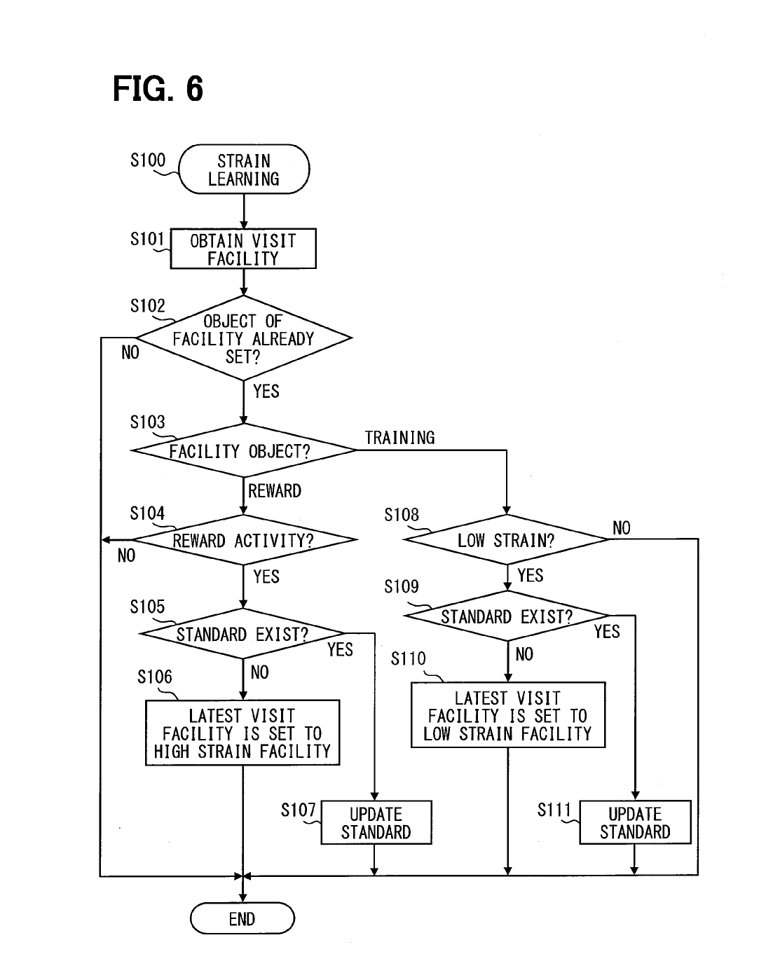

The navigation ECU 40 executes the strain learning process S100 shown in FIG. 6. The strain learning process includes: performing the learning of the determination standard with respect to a certain facility; and further setting the undetermined strain type of the facility to be the high strain facility or the low strain facility. The strain learning process is executed when the visit place of the vehicle is determined under a state that the destination is not proposed at step S5 in FIG. 2.

At step S101, the visit facility is obtained from the activity record in the memory unit 10. At step S102, it is determined whether the facility object of the visit facility obtained at step S101 is already set or not. Here, the facility object is information in the facility information. The facility object indicates that the facility is the reward facility or the training facility. The facility object is defined at each user.

When the facility object of the visit facility obtained at step S101 is not defined (i.e., when step S102 is NO), the process in FIG. 6 ends. On the other hand, when the facility object of the visit facility obtained at step S101 is defined, the user went to the reward facility or the training facility although the destination proposal at step S5 in FIG. 2 is not executed.

At step S103, the facility object is determined to the reward or the training. When the facility object is the reward, it goes to step S104. When the facility object is the training, it goes to step S108.

At step S104, it is determined whether the activity of the user who went to the reward facility is based on the reward activity or not reward activity such as a case where the user went to the reward facility since the user have time although the mental strain is not so high.

The above determination is performed based on the visit time at the visit facility (the last visit facility), which the user has stayed for predetermine time or longer, or the user has visited at a predetermined frequency during a predetermined period before the user visits the visit facility obtained at step S101. When the visit time at the last visit facility is long, or when the visit frequency at the last visit facility is large, the mental strain of the user becomes high because of the visit or the stay at the facility. As a result, it is estimated that the user takes a reward action such that the user goes to the reward facility.

The determination whether the visit time at the last visit facility is long, or the determination whether the visit frequency is large, is performed with reference to the determination standard that is already set when the determination standard is already set to determine that the mental strain at the last visit facility is already high. When it is determined that a gap of the activity record of the user is overlarge with respect to the determination standard, it is determined that the user did not go to the visit facility with the reward object. The determination whether the gap is large or not is performed according to the determination whether the visit time is equal to or smaller than a predetermined ratio from α hours in the determination standard at the present time, or the determination whether the running days and the frequency are equal to or smaller than a predetermined ratio of a value in the determination standard.

On the other hand, when the determination standard for determining that the mental strain is high is not set, the determination is performed with reference to an average determination standard, which is preliminary set to determine that the mental strain is high. The average determination standard includes the same items as the already-set determination standard such as the α hours, the running days, the frequency, and the visit frequency. Average values of the items as concrete values are set in the average determination standard. The reference method of the average determination standard is similar to a case where the already-set determination standard is addressed.

As a result of the determination at step S104, when it is determined that it is not the reward action, the process in FIG. 6 ends. On the other hand, when it is determined that it is the reward action, it goes to step S105. At step S105, it is determined whether the determination standard for determining the high strain exists with respect to the last visit facility. When no standard exists, it goes to step S106. When the standard exists, it goes to step S107.

At step S106, the last visit facility is defined as the high strain facility. Further, the determination standard with respect to the facility is set to be the above average determination standard. Alternatively, the determination standard may be set based on the activity record.

At step S107, the already-set determination standard for determining that the mental strain is high is updated. The process in FIG. 6 is executed when the visit place of the vehicle is determined in a state that the destination proposal is not performed at step S5 in FIG. 2. Thus, when step S107 is performed, it is considered that the determination standard does not meet the feeling of the user. Thus, one item of the determination standard, which is not satisfied at the visit of the last visit facility, is changed by predetermined value, or one item is changed to meet the activity record with the determination standard. Here, the change of the determination standard may be in a case where the previous value is reduced or a case where the previous value is increased. The case where the previous value is increased is a case where the destination proposal is performed multiple times based on the continuous visit with respect to the same visit place, and further a case where the user did not go to the reward facility, which is proposed, with respect to the previous destination proposal.

Next, a case where the facility object determined at step S103 is the training object will be explained. In this case, at step S108, it is determined whether the action of the user who went to the training facility is derived from a reason that the mental strain is too small, or whether it is considered that the user went to the training facility because of other reasons although the mental strain is not too small.

The above determination is also performed according to the visit time at the last visit facility. When the visit time at the last visit facility is shorter than the normal time, it is determined that the mental strain is too small. The determination whether the visit time at the last visit facility is shorter than the normal time is performed with reference to the already-set determination standard when the determination standard for determining that the mental strain is low is already set at the last visit facility. When the determination standard for determining that the mental strain is low is not set, the determination is performed with reference to the average determination standard, which is preliminary set to determine that the mental strain is low. Using these determination standards, when it is determined that the gap of the activity record of the user is too large, it is determined that the mental strain is not too small (i.e., step S108 is NO). When it is determined that the gap of the activity record of the user is small, it is determined that the mental strain is too small (i.e., step S108 is YES).

When the determination at step S108 is NO, the process in FIG. 6 ends. When the determination at step S108 is YES, it goes to step S109. At step S109, it is determined whether the determination standard for determining the low strain exists with respect to the last visit facility. When no determination standard exists, it goes to step S110. When the standard exists, it goes to step S111.

At step S110, the last visit facility is set to be the low strain facility. The determination standard with respect to this facility is set to be the average determination standard, which is preliminary set to determine that the mental strain is low. Alternatively, the determination standard may be set based on the activity record. At step S111, the already-set determination standard for determining that the mental strain is low is updated similar to step S107.

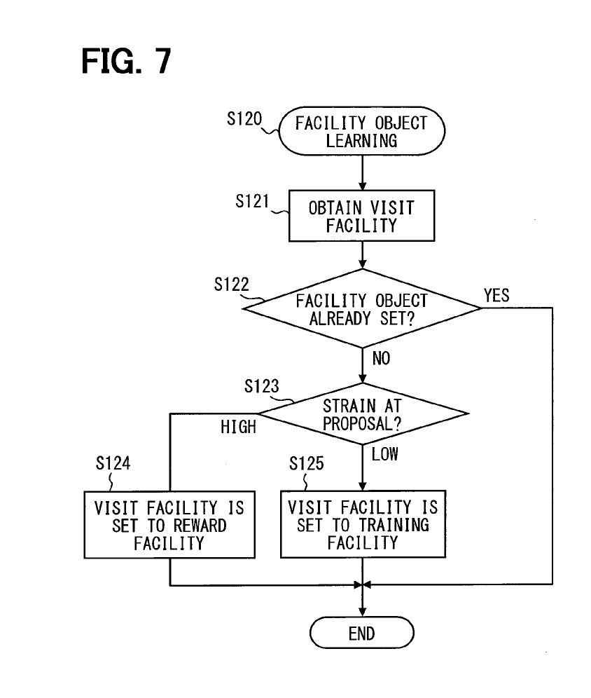

The navigation ECU 40 also executes the facility object learning process S120 in FIG. 7. The facility object indicates the reward facility or the training facility as described above. The process in FIG. 7 is executed every time when it reaches a state for determining the visit place after the destination proposal at step S5 in FIG. 2 is performed, and the transfer of the vehicle ends.

At step S121, the visit facility is obtained from the activity record of the memory unit 10. At step S122, it is determined whether the facility object of the visit facility obtained at step S121 is already set. When the determination is YES, it is not necessary to learn the facility object. Therefore, the process in FIG. 7 ends. When the visit facility obtained at step S121 is the destination proposed at step S5 in FIG. 2, the facility object is definitely already set, and therefore, step S122 is YES. Thus, step S122 is NO when the user did not go to the destination proposed at step S5 in FIG. 2.

When the determination at step S122 is NO, it goes to step S123. At step S123, the mental strain is determined when the destination proposal is performed at step S5 in FIG. 2. When the mental strain is high, it goes to step S124. When the mental strain is low, it goes to step S125.

At step S124, since the user went to the facility after it is determined that the mental strain is high although the visit facility obtained at step S121 is different from the proposed facility, this visit facility is set to be the reward facility with respect to the user. On the other hand, at step S125, the visit facility obtained at step S121 is set to be the training facility with respect to the user.

Thus, the effects according to the present embodiment will be explained. Previous activities of the user greatly influence the mental strain of the user. For example, when the overtime work longer than usual continues, the user feels tired. When the user continuously leaves at the regular time recently although the overtime work has been a lot a short time ago, the mental strain becomes too small, and therefore, the user may feel to train by himself or herself using spare time, which is generated since the working time becomes short.

Accordingly, in the present embodiment, the moving record as one of the activity records of the user is successively updated (at step S1), and the mental strain of the user at that time is estimated based on the moving record (at step S2), so that the mental strain of the user at that time is estimated with high accuracy. Further, the estimated mental strain is used as the search condition of the destination proposal, and thus, the proposed destination is determined (at steps S3 and S4). Accordingly, the destination proposal according to the mental strain of the user is executed.

Further, the moving record used for estimating the mental strain of the user is updated automatically and successively by obtaining the moving information of the user (at step S1). Thus, time and effort of an operation of the user are reduced.

(Modification 1)

In the above described embodiment, the action to be proposed when it is determined that the mental strain is high is to move to the reward facility. Instead of proposing the transfer to the reward facility, it may be proposed to purchase a product, which is preferable for the user. Here, the product preferable for the user is determined based on the purchase record of the user.

(Modification 2)

Further, in the above described embodiment, the vehicular navigation device 1 has a function of the activity proposing device of the present disclosure. Alternatively, as described in the previous embodiment, the mobile terminal may have the function of the activity proposing device of the present disclosure. Further, in the above described embodiment, the mobile terminal includes the navigation function, the position detection function and the Internet connection function. The route guidance function is not always necessary for the present disclosure. Thus, the navigation function and the position detection function are not always necessary. Further; it is not necessary to generate and update the product buying and purchasing record in the mobile terminal if the communication device for obtaining the activity record from an external device is equipped.

(Modification 3)

In the previous embodiment, the memory unit 10 for storing the activity record is equipped, and the process for updating the activity record stored in the memory unit 10 is executed by the navigation ECU 40. Alternatively, the activity record of the user may be obtained from an external device. In this case, it is not necessary to equip the memory unit for storing the activity record and a device for updating the activity record, in the vehicular navigation device 1.

(Modification 4)

In the previous embodiment, the level of the mental strain is estimated as the mood of the user. Alternatively, other types of mood such as joy and sorrow may be estimated based on the activity record of the user.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the mood estimation device estimates that the mental strain of the user is high when running days or a frequency of days, on which a visit time at a place set as a mental strain increasing place is equal to or longer by predetermined time than an average visit time, are equal to or more than a determination value.

2. The activity proposing device according to claim 1, further comprising:
a memory unit that stores the activity record of the user; and
a record updating device that obtains information indicative of an activity of the user, and successively updating the activity record stored in the memory unit,
wherein the mood estimation device estimates the mood of the user at the present time based on the activity record stored in the memory unit.

3. The activity proposing device according to claim 1,
wherein the proposal determination device sets an activity to go to a destination as the activity to be proposed.

4-5. (canceled)

6. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the mood estimation device estimates that the mental strain of the user is low when running days or a frequency of days, on which a visit time at a place set as a mental strain increasing place is equal to or shorter by predetermined time than an average visit time, are equal to or more than a determination value.

7. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the mood estimation device estimates that the mental strain of the user is high when a visit frequency of a place set as a mental strain increasing place is equal to or higher than a determination value.

8. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the mood estimation device estimates that the mental strain of the user is high when the number of facilities stopped over on the same day is equal to or larger than a determination facility number.

9. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the mood estimation device estimates that the mental strain of the user is low when a visit time at a certain place is equal to or shorter by a predetermined time than an average visit time after a day, on which a visit time at the certain place set as a mental strain increasing place is equal to or longer by predetermined time than an average visit time, continues.

10. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the proposal determination device determines an activity to go to a mental strain reducing facility as the activity to be proposed, the mental strain reducing facility set for reducing the mental strain, when the mood estimation device estimates that the mental strain is high.

11. The activity proposing device according to claim 10,
wherein the proposal determination device determines the mental strain reducing facility, which the user has been to for a predetermined past period, based on the activity record of the user, and
wherein the proposal determination device sets a facility, which the user has not been to for the predetermined past period, as a mental strain reducing facility to be proposed.

12. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed; and
a display unit that displays the activity determined by the proposal determination device,
wherein the mood estimation device estimates a level of a mental strain as the mood of the user, and
wherein the proposal determination device determines an activity to go to a mental strain increasing facility, which is set for increasing the mental strain, as the activity to be proposed when the mood estimation device estimates that the mental strain is low.

13. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed;
a display unit that displays the activity determined by the proposal determination device; and
a strain learning device that executes a learning that a facility visited by the user before going to a mental strain reducing facility is a mental strain increasing facility when it is determined that the user has been to the mental strain reducing facility set for reducing the mental strain after the mental strain is increased,
wherein the mood estimation device estimates a level of a mental strain as the mood of the user.

14. An activity proposing device comprising:
a mood estimation device that estimates a mood of a user at a present time based on an activity record of the user;
a proposal determination device that determines an activity to be proposed to the user using the mood estimated by the mood estimation device as a selection condition of the activity to be proposed;
a display unit that displays the activity determined by the proposal determination device; and
a facility object learning device executes a learning that a facility the user has been to is a mental strain reducing facility with respect to the user when the activity determined by the proposal determination device in a case where the mood estimation device estimates that the mental strain is high is to go to the mental strain reducing facility set for reducing the mental strain, the display unit has displayed the activity, and the has been to a facility different from the facility displayed on the display unit,
wherein the mood estimation device estimates a level of a mental strain as the mood of the user.
